(19) United States
(12) Patent Application Publication
(10) Pub. No.: US 2025/0346393 A1
(43) Pub. Date: Nov. 13, 2025

(54) TWO PART STORAGE CONTAINER WITH AN ASSEMBLED CONFIGURATION AND A SPLIT CONFIGURATION

(71) Applicant: AutoStore Technology AS, Nedre Vats (NO)

(72) Inventor: Staffan Hörnlund, Drammen (NO)

(21) Appl. No.: 18/859,735

(22) PCT Filed: Apr. 14, 2023
(86) PCT No.: PCT/EP2023/059744

§ 371 Date: Oct. 24, 2024

(30) Foreign Application Priority Data
Apr. 29, 2022 (NO) 20220483

(51) Int. Cl. B65D 6/24; B65D 21/02; B65G 1/06

(52) U.S. Cl. CPC B65D 11/188; B65D 21/0217; B65G 1/065

(57) ABSTRACT

The present invention relates to a two part storage container (10) for storing a product item (80) in an automated storage and retrieval system (1). The storage container (10), in an assembled configuration, comprises a base panel (11) and four side panels (12) extending from the base panel (11). The base panel (11) and the four side panels (12) define a storage space. The storage container (10) has a top opening (13) to provide access to the storage space. The two parts of the storage container (10) comprise an upper container section (20) comprising at least two of the side panels (12a) and a lower container section (30) comprising at least the base panel (11). The upper container section (20) and the lower container section (30) are configured to allow vertical movement of the upper container section (20) relative to the lower container section (30). The storage container (10) is in a split configuration when the upper container section (20) is moved vertically relative to the lower container section (30).

### FIELD OF THE INVENTION

The present invention relates to a two part storage container for storing a product item in an automated storage and retrieval system. The present invention also relates to an automated storage and retrieval system comprising a framework structure and a storage volume comprising storage columns for storing such two part storage containers. The present invention also relates to a method for loading and unloading an item from a container space of the two part storage container.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c, 301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1. . . n and Y=1. . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2021/089305 describes a set of moulded panels which can be assembled together to form a storage container for an automated storage and retrieval system. When in use in the automated storage and retrieval system, the panels are always assembled as a storage container.

WO 2019/238642 and WO 2020/109495describes an unloading arrangement, an unloading station, and a method of unloading an item from a storage container. It is also described a storage container with a side opening, where product items stored in the storage containers can be move sideways out through the side opening of the storage container.

### SUMMARY OF THE INVENTION

The present invention relates toa two part storage container for storing a product item in an automated storage and retrieval system, wherein the storage container, in an assembled configuration, comprises:
a base panel; and
four side panels extending from the base panel;
   wherein the base panel and the four side panels define a storage space, the storage container having a top opening to provide access to the storage space and wherein the two parts of the storage container comprise:
an upper container section comprising at least two of the side panels; and
a lower container section comprising at least the base panel;
   wherein the upper container section and the lower container section are configured to allow vertical movement of the upper container section relative to the lower container section;
   wherein the storage container is in a split configuration when the upper container section is moved vertically relative to the lower container section.

In one aspect, the storage container in the assembled configuration prevents the product item from exiting the storage space; and wherein the storage container in the split configuration allows the product item to be moved out sideways from the storage space.

In one aspect, the two part storage container comprises an interface configured to bring the two part storage container between its assembled configuration and its split configuration.

In one aspect, the product item is stored in a delivery container within the storage container and wherein the storage container in the assembled configuration prevents the delivery container from exiting the storage space; and wherein the storage container in the split configuration allows the delivery container to be moved out sideways from the storage space.

In one aspect, the upper container section is at least partially separated from the lower container section in the split configuration.

In one aspect, the upper container section is entirely separated from the lower container section in the split configuration.

In one aspect, the upper container section comprises all four side panels.

In one aspect, the lower container section comprises only the base panel.

In one aspect, the upper container section comprises two side panels.

In one aspect, the two side panels of the upper container section are of the same size and are arranged on opposite sides of the container space.

In one aspect, the lower container section comprises two side panels.

In one aspect, the two side panels of the lower container section are of the same size and are arranged on opposite sides of the container space.

In one aspect, the upper container section comprises cross members that connect the two side panels of the upper container section to each other.

In one aspect, the upper edge of the two side panels of the upper container section and the cross members defines the top opening.

In one aspect, the two side panels of the upper container section slidingly engage with the two side panels of the lower container section in at least the assembled configuration.

In one aspect, the two side panels of the upper container section slidingly engage in recesses in the two side panels of the lower container section.

In one aspect, the interface comprises:
a first opening provided in the upper container section;
a second opening provided in the lower container section; wherein the first opening is provided above the second opening.

In one aspect, the second opening is vertically aligned below the first opening in at least the assembled configuration.

In one aspect, the interface comprises four first openings and four second openings.

In one aspect, each of the first openings is vertically aligned above one of the respective second openings in at least the assembled configuration.

In one aspect, the first opening is provided in the cross member of the upper container section and the second opening is provided in the side wall of the lower container section.

In one aspect, the interface comprises:
a first opening provided in the upper container section;
a locking device integrated in the base panel, wherein the locking device releasably locks the base panel to at least two of the side walls in the assembled configuration.

In one aspect, the base panel comprises an aperture, wherein the side wall comprises a lug insertable into the aperture, wherein the locking device comprises a pin for releasable locking of the lug in the aperture.

In one aspect, the pin is spring-biased to its locked position.

In one aspect, the first opening is engageable by a gripper of a lifting device of a container handling vehicle.

In one aspect, the second opening is engageable by a gripper of a lifting device of a container handling vehicle.

The present invention also relates to an automated storage and retrieval system comprising a framework structure and a storage volume comprising storage columns, wherein a product item is stored within a two part storage container according to any one of the preceding claims, wherein the storage container is stackable in stacks within the storage columns; wherein the automated storage and retrieval system comprises:
a loading and/or unloading station comprising an actuator;
a lifting device comprising a gripper for lifting the upper container section relative to the lower container section;
   wherein the system is configured to:
bring the two part storage container from an assembled configuration to a split configuration at the loading and/or unloading station by means of the lifting device;
- load the product item into the lower container section by means of the first actuator or unload the product item from the lower container section by means of the first actuator.

In one aspect, the lifting device is arranged on a container handling vehicle.

In one aspect, the framework structure comprises upright members defining the storage columns and a rail system arranged across the top of the framework structure, wherein the container handling vehicle is operating on the rail system.

In one aspect, the gripper is arranged to engage the first opening provided in the upper container section.

In one aspect, the gripper is arranged to selectively engage the first opening in the upper container section and/or the second opening provided in the lower container section.

In one aspect, the second opening is vertically aligned below the first opening in at least the assembled configuration, and wherein the gripper has an height sufficiently large to be inserted into the first opening and the second opening in the assembled configuration.

In one aspect, the loading and/or unloading station comprises a second actuator for operating the locking device integrated in the base panel, wherein the system is configured to:
bring the storage container from the assembled configuration to the split configuration at the loading and/or unloading station by means of the lifting device lifting the upper container section with respect to the lower container section and the second actuator operating the locking device.

In one aspect, the loading and/or unloading station comprises a base onto which the storage container is received. The base may be located in the lower end of one of the storage columns of the framework structure. Hence, a container handling vehicle may move the two part storage container in its assembled configuration from a storage position within the framework structure to the base of the loading and/or unloading station. The same container handling vehicle may subsequently split the two part storage container to its split configuration, thereby allowing the actuator of the station to unload or load a product item or a delivery container into or from the two part storage container. The same container handling vehicle may subsequently bring the two part storage container to its assembled configuration before moving it to a storage position within the framework structure again.

The present invention also relates to a method for loading and unloading an item from a container space of the two part storage container above, wherein the method comprises the steps of:
transporting the two part storage container to a loading and/or unloading station;
bringing the two part storage container from an assembled configuration to a split configuration at the loading and/or unloading station by means of a lifting device comprising a gripper;
load the product item into the lower container section by means of a first actuator or unload the product item from the lower container section by means of the first actuator.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a prior art storage container containing product items.

FIG. 6 is a perspective view of an assembly line with delivery containers.

FIG. 7a is a perspective view of a two part storage container in the assembled configuration.

FIG. 7b is a perspective view of a two part storage container in the split configuration.

FIG. 8a is a cross sectional view the delivery container stored within the two part storage container.

FIG. 8b is a schematical side view of how a delivery container is removed from the two part storage container of FIG. 8a.

FIG. 9a is a perspective view of a second embodiment of the two part storage container in the assembled configuration.

FIG. 9b is a perspective view of the two part storage container of FIG. 9a in the split configuration.

FIG. 10a illustrates a top view of a locking device integrated in the base panel in a locked state.

FIG. 10b illustrates the locking device integrated in the base panel in FIG. 10a in an unlocked state.

FIG. 11a illustrates how a prior art gripping device is inserted into the connection interface of the prior art storage container of FIG. 5.

FIG. 11b illustrates how the prior art gripping device is engaged with the connection interface in order to lift the storage container of FIG. 5.

FIG. 12a illustrates how a gripper device is inserted into the connection interface of the storage container of FIG. 7a and FIG. 7b.

FIG. 12b illustrates how the upper section and the lower section of the storage container of FIG. 7a and FIG. 7b is lifted by the gripper device.

FIG. 12c illustrates how only the upper section of the storage container of FIG. 7a and FIG. 7b is lifted by the gripper device.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

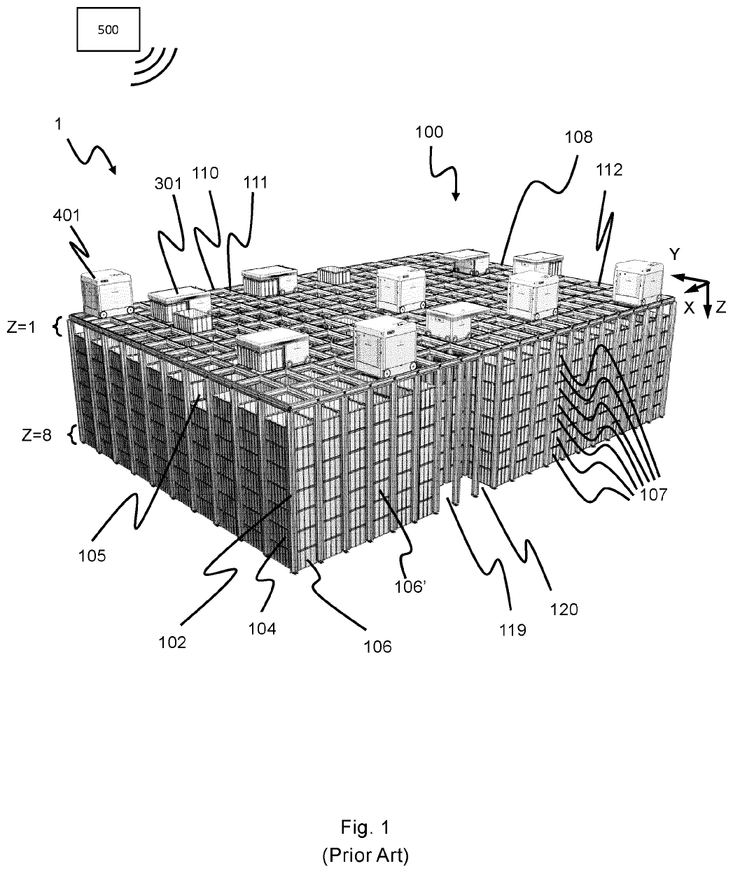

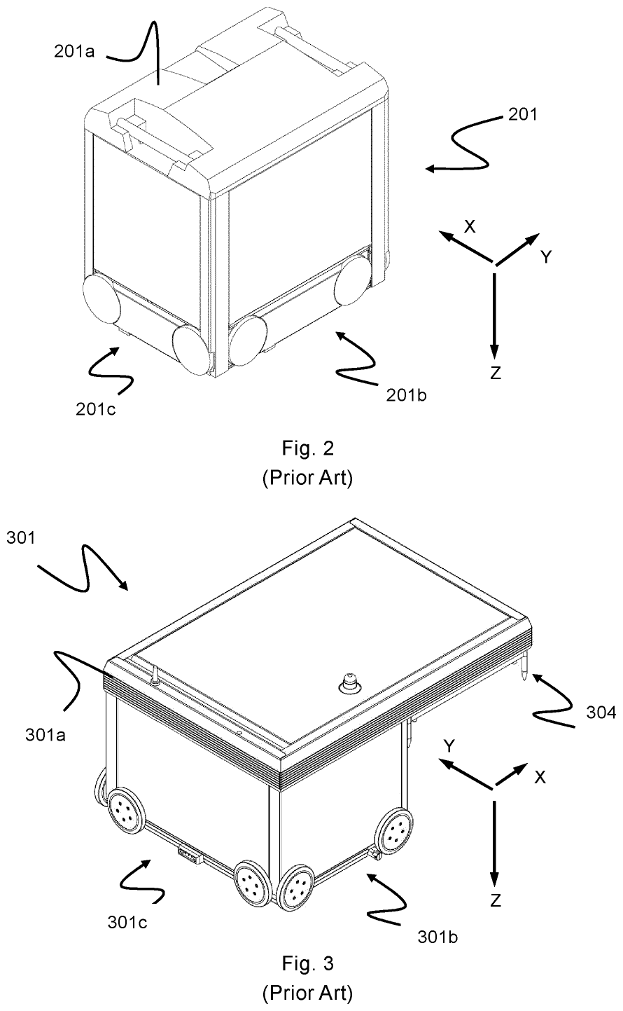

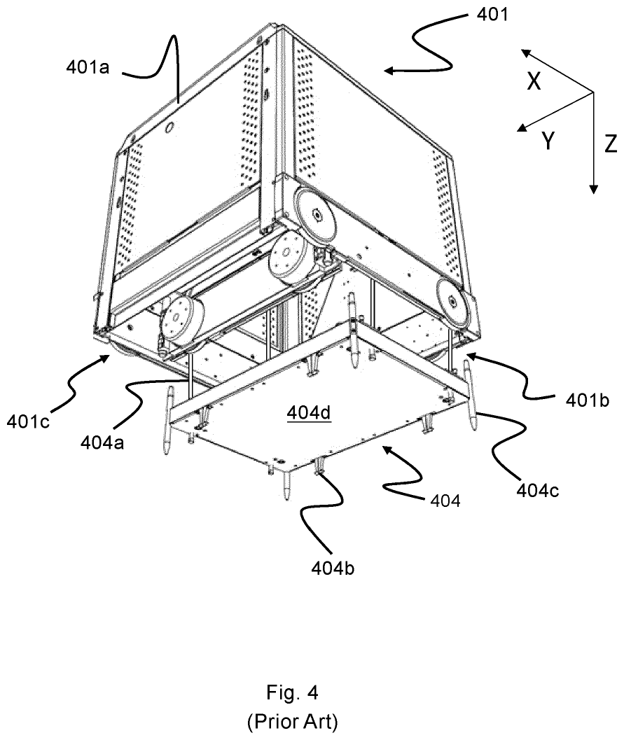

The framework structure 100 of the automated storage and retrieval system 1 is constructed in a similar manner to the prior art framework structure 100 described above in connection with FIGS. 1-4. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

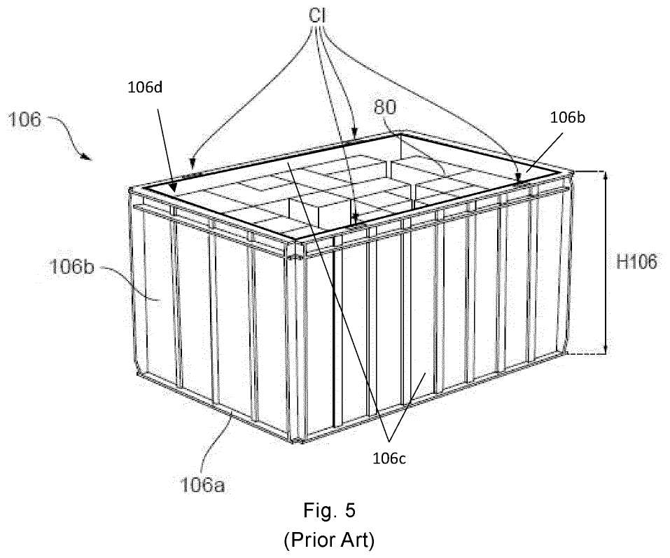

Initially, it is referred to FIG. 5, showing a prior art storage container 106 having a base panel 106a and side panels 106b, 106c extending from the base panel 106a.

The base panel 106a and the side panels 106b, 106c defines a storage compartment in which product items 80 may be stored. The upper edges of the side panels 106b, 106c defines a rectangular top opening 106d through which product items 80 may be inserted into the storage compartment and through which product items 80 may be retrieved from the storage compartment.

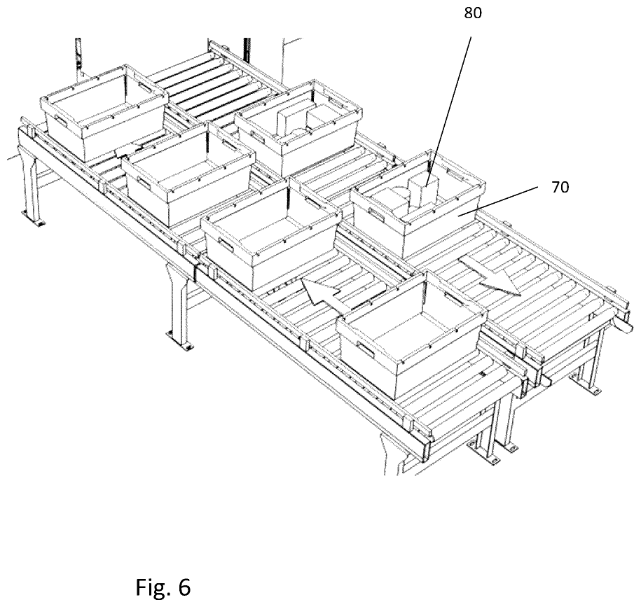

FIG. 6 shows two conveyors on which a number of delivery containers 70 are provided. The delivery containers 70 also contains product items 80. One delivery container 70 may be stored within one storage container 106.

Typically, the storage containers 106 are used to store either product items 80 or delivery containers 70 containing product items 80 within the automated storage and retrieval system 1. Hence, the storage containers 106 are designed for the purpose of being stacked above each other and for the purpose of being lifted by the container handling vehicles 201, 301, 401. The delivery container 70 are used for delivery of product items 80 from the automated storage and retrieval system 1 to a target destination. The delivery containers 70 may for example be designed based on requirements at the target destination.

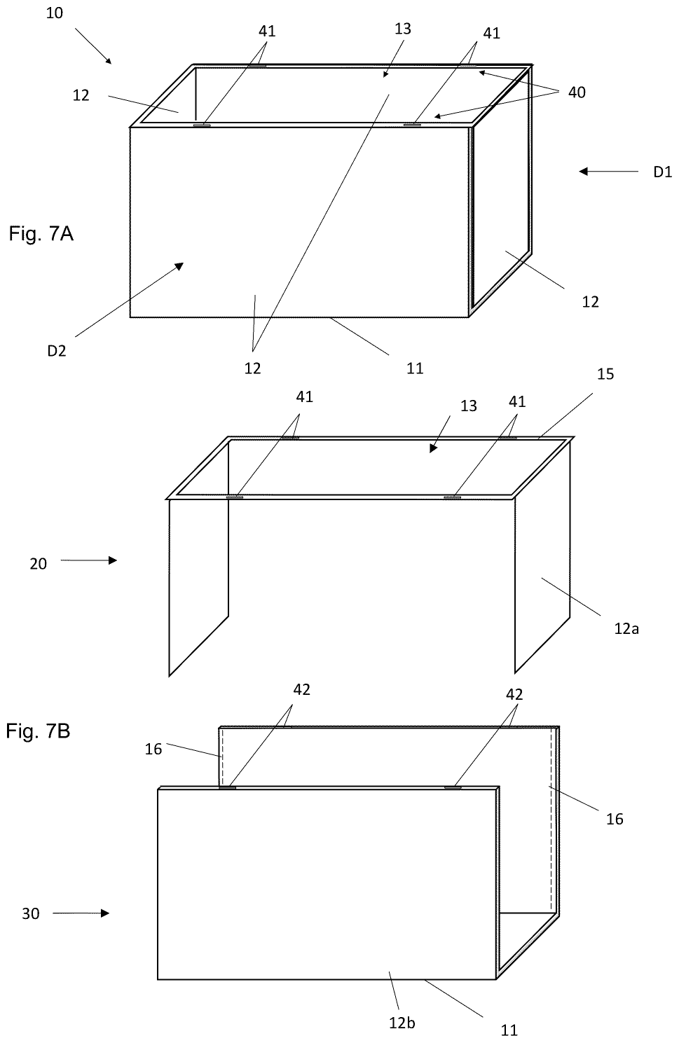

It is now referred to FIG. 7a, where a two part storage container 10 is shown. The two part storage container 10 may be used in a similar way as the prior art storage container 106 in FIG. 5, i.e. it can be stacked in the stacks 107 within the storage columns 105 within the framework structure 100, it can be lifted by the lifting device of container handling vehicles 201, 301, 401, it can be used to store product items 80 or a delivery container 70. In addition, the two part storage container 10 has some additional properties, which will be apparent from the description below.

The two part storage container 10 can be in an assembled configuration shown in FIG. 7a. In its assembled configuration, the storage container 10 comprises a base panel 11 and four side panels 12 extending from the base panel 11. The base panel 11 and the four side panels 12 define a storage space for product items 80 or the delivery container 70. The storage container 10 has a top opening 13 to provide access to the storage space. In the assembled configuration, the side panels 12 prevent the product item 80 and/or the delivery container 70 from exiting the storage space.

The two part storage container 10 comprises two parts. The first part is an upper container section 20 comprising at least two of the side panels 12a. The second part is a lower container section 30 comprising at least the base panel 11. The upper container section 20 and the lower container section 30 are configured to allow vertical movement of the upper container section 20 relative to the lower container section 30.

The two part storage container 10 can also be in a split configuration shown in FIG. 7b. In its split configuration, the upper container section 20 is moved vertically relative to the lower container section 30.

The two part storage container 10 has a lower stacking interface similar to the lower stacking interface of the prior art storage container 106 and an upper stacking interface similar to the upper stacking interface of the prior art storage container 106. Hence, the storage container may be stacked above another storage container 10 or the prior art storage container 106, and other two part storage containers 10 or a prior art storage container 106 may be stacked above the two part storage container 10.

The storage container 10 in the assembled configuration prevents the product item 80 or the delivery container 70 from exiting the storage space; and wherein the storage container 10 in the split configuration allows the product item 80 or the delivery container 70 to be moved out sideways from the storage space.

The two part storage container 10 further comprises an interface 40 configured to bring the two part storage container 10 between its assembled configuration and its split configuration.

As will be apparent from the description below, parts of the interface 40 is also engageable by a gripper 404b of a lifting device 404 for bringing the storage container between its assembled configuration and its split configuration. This will be described further in detail below.

### First Embodiment

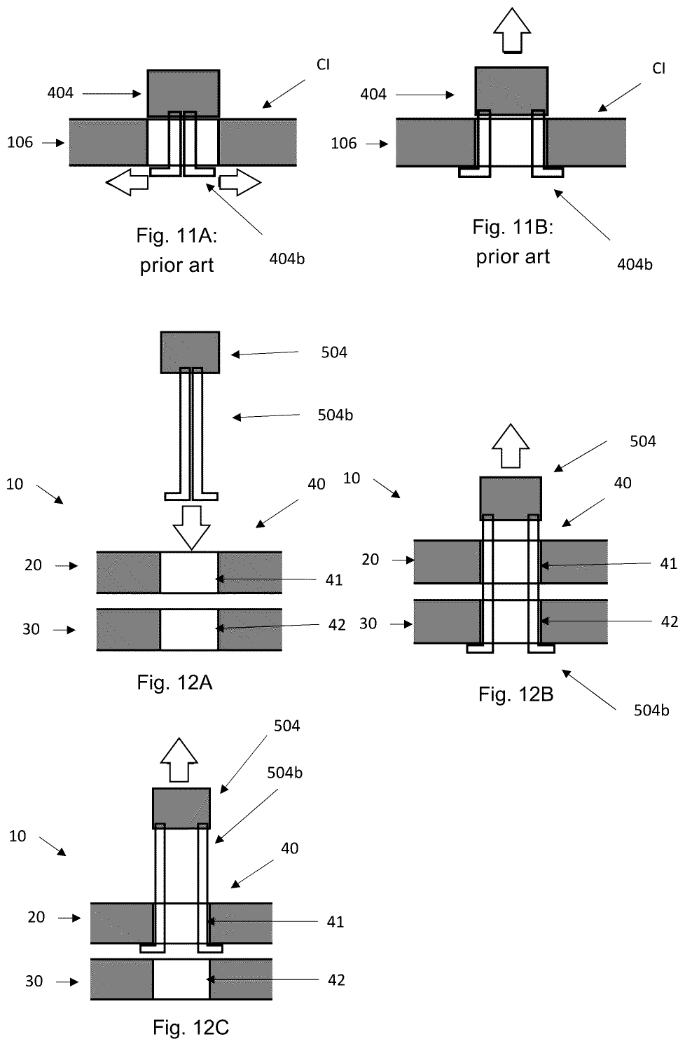

The first embodiment is shown in FIG. 7a, FIG. 7b and FIG. 12a-12c.

In FIG. 7b it is shown that the upper container section 20 comprises two side panels 12a and cross members 15 that connect the two side panels 12a of the upper container section 20 to each other. The two side panels 12a of the upper container section are of the same size and are arranged opposite sides of the container space. The upper edge of the two side panels 12a and the cross members 15 defines the top opening 13.

The lower container section 30 comprises two side panels 12b connected to each other via the base panel 11. Also the two side panels 12b of the lower container section are of the same size and are arranged on opposite sides of the container space. As shown, the side panels 12a of the upper container section are perpendicular to the side panels 12b of the lower container section.

It is further shown that the two side panels 12b of the lower container section 30 comprises recesses 16 (indicated by a dashed line in FIG. 7b). The two side panels 12a of the upper container section 20 slidingly engage with these recesses 16 of the two side panels 12b of the lower container section 30.

It should be noted that the upper container section 20 may be entirely separated from the lower container section 20 in the split configuration. Here, the two side panels 12a of the upper container section 20 are no longer slidingly engaged with the recesses. Hence, the two side panels 12a of the upper container section 20 will be slidingly engaged with the recesses only in the assembled configuration and during movement of the upper container section 20 to and from the split configuration.

However, it should be noted that the upper container section 20 may be prevented from being entirely separated from the lower container section 20 in the split configuration. Here the two side panels 12a of the upper container section 20 will always be slidingly engaged with the recesses 16 in the split configuration and in the assembled configuration. This can be achieved by means of a stop or similar mechanical property of the two part storage container 10, or it can be achieved by the control of the lifting device used to move the upper container section 20 relative to the lower container section 30.

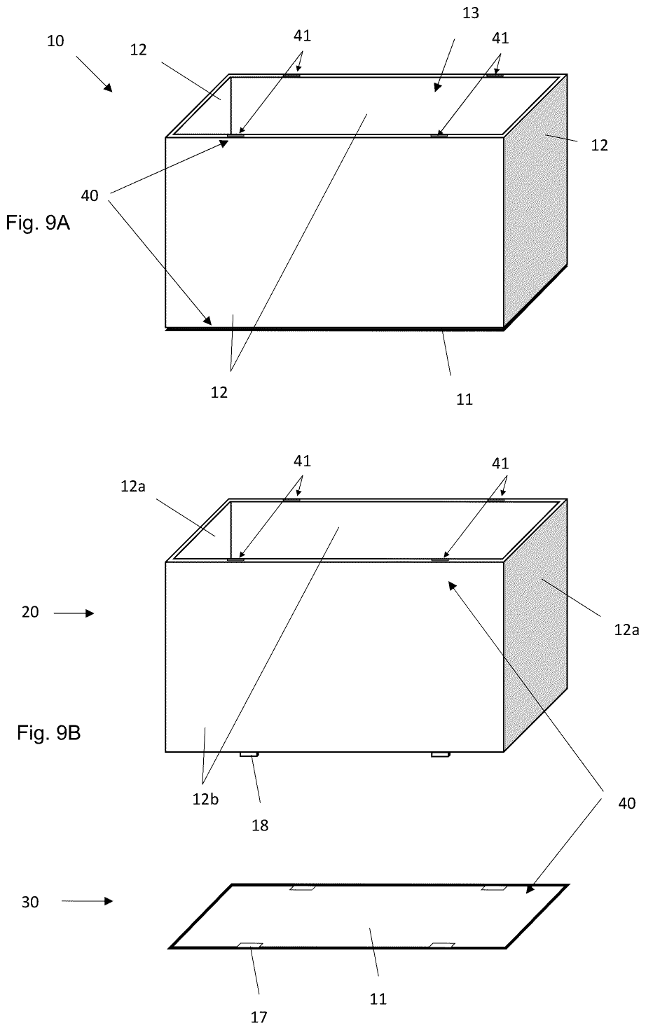

In the present embodiment, the interface 40 comprises four first openings 41 provided in the cross member 15 of the upper container section 20 and four second openings 42 provided in the upper end of the two side walls 12b of the lower container section 30. As shown in FIGS. 9a, 9b and 9c, each second opening 42 is vertically aligned below its respective first opening 41.

### Second Embodiment

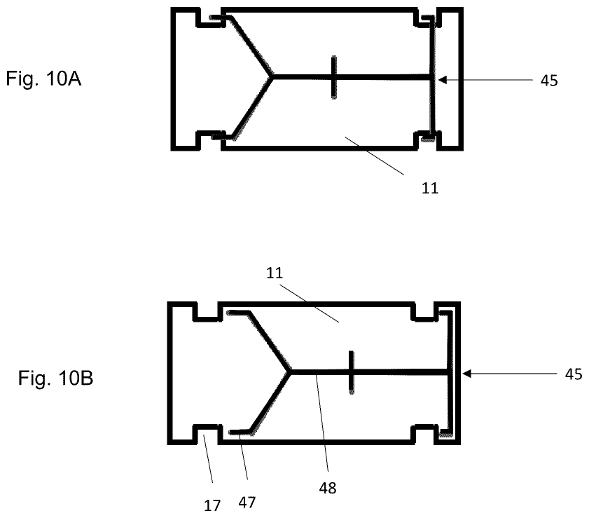

The second embodiment is shown in FIG. 9a, FIG. 9b, FIG. 10a and FIG. 10b.

In FIG. 9b it is shown that the upper container section 20 comprises all four side panels 12a, 12b. The upper edge of the four side panels 12a, 12b defines the top opening 13. The side wall 12b comprises four lugs 18 protruding downwardly towards the base panel 11.

In FIG. 9b it is further shown that the lower container section 30 comprises only the base panel 11. The base panel 11 comprises four apertures 17 in which the lugs 18 are receivable, i.e. the lugs 18 are insertable into the apertures 17.

In the present embodiment, the interface 40 comprises four openings 41 provided in the upper container section 20 similar to the first openings of the first embodiment. The interface 40 does not comprise a second opening aligned directly below the first opening. Instead, the interface 40 comprises a locking device 45 integrated in the base panel 11.

The locking device 45 comprises pins 47 for releasable locking of the lugs 18 in their respective apertures 17. The pins 47 are spring-biased to its locked position. In FIG. 10a and FIG. 10b, the pins are connected to each other by a strut structure 48.

When the lugs 18 are inserted into their respective apertures 17 and the has locked the lugs 18 in their respective openings (pins 47 in the position shown in FIG. 10a), the two part storage container is the assembled configuration (shown in FIG. 9a). The entire storage container may now be lifted via the openings 41.

When the has not locked the lugs 18 in their respective openings (pins 47 in the position shown in FIG. 10b), the upper section 20 with its lugs 18 may be lifted up from the apertures 17. Hence, the upper section may be lifted up from the lower section, and the storage container is in its split configuration (shown in FIG. 9b).

### The Lifting Device With Gripper

It is now referred to FIG. 12a, FIG. 12b, FIG. 12c, where a lifting device 504 with a gripper 504b is shown. It should be noted that the lifting device 504 will comprise four such grippers 504b to operate the above two-part storage containers, due to the four first openings 41 and four second openings 42 of the first embodiment of the first embodiment and the four openings 41 of the second embodiment.

The gripper 504b has two L-shaped elements horizontally movable relative to each other, similar to the L-shaped elements of the prior art gripper 404b of the prior art lifting device 404 in FIG. 11a and FIG. 1b. However, the two L-shaped elements of the gripper 504b has a height sufficiently large to be inserted into the first opening 41 and the second opening 42 of the first embodiment above when the two part storage container 10 is in the assembled configuration, as shown in FIG. 12a and FIG. 12b.

The gripper 504b may be inserted into the first opening 41 and the second opening 42 as shown in FIG. 12b and then be engaged with the lower opening 42 by moving the L-shaped elements away from each other. When the lifting device 504 is lifted upwardly, the upper container section 20 and the lower container section 30 are lifted together, i.e. the two part storage container 10 is lifted in its assembled configuration.

The gripper 504b may also be inserted into the first opening 41 only, as shown in FIG. 12c and then be engaged with the first opening 41 by moving the L-shaped elements away from each other. When the lifting device 504 is lifted upwardly, the upper container section 20 is lifted relative to the lower container section 30, i.e. the two part storage container 10 is brought to its split configuration.

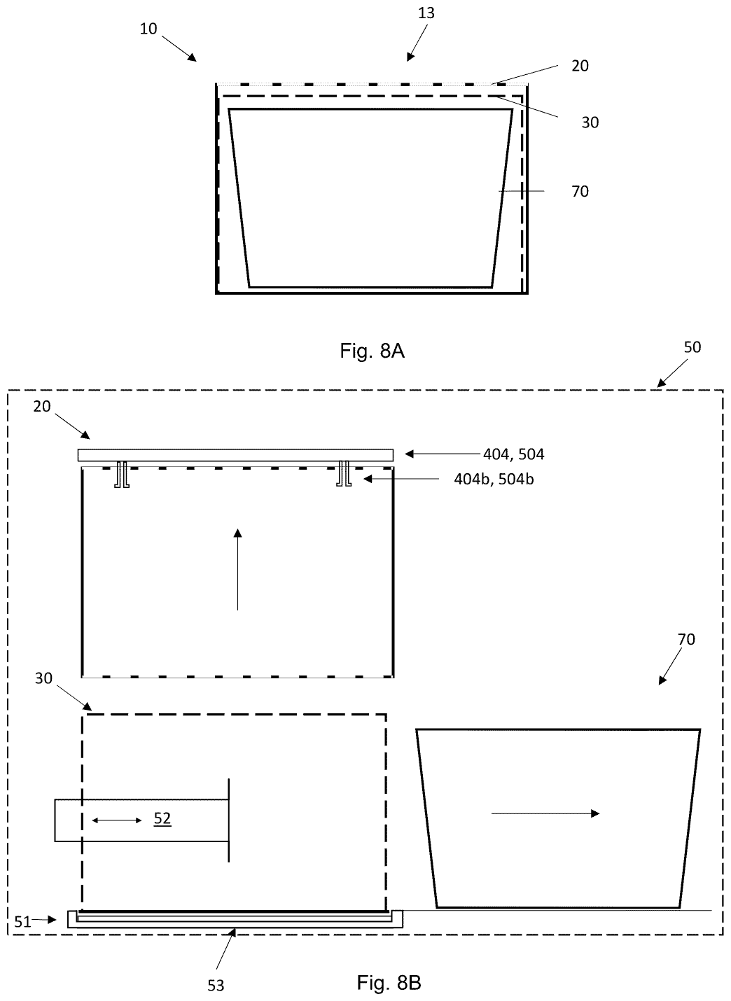

The lifting device 504 with its gripper 504b may be a lifting device of a container handling vehicle, similar to the container handling vehicle 201, 301, 401. However, the lifting device 504 may also be a separate lifting device mounted as part of a loading and/or unloading station 50 (shown in FIG. 8b)

### The Loading and/or Unloading Station 50

It is now referred to FIG. 8a. Here, the delivery container 70 is shown within the two-part container 10. As shown, a product item 80 can be inserted into and/or retrieved from the deliver container via the top opening 13.

A dashed box 50 is generally indicating a loading and/or unloading station 50 for loading one or more product items 80 or a delivery container containing one or more product items 80 into the two part storage container 10 or for unloading one or more product items 80 or a delivery container containing one or more product items 80 out from the two part storage container 10.

In a first embodiment of the loading and/or unloading station 50 it is assumed that the first embodiment of the two part storage container 10 is used. Here, the loading and/or unloading station 50 comprises a base 51 onto which the storage container 10 is received. The base may be located in the lower end of one of the storage columns 105 of the framework structure 100. Hence, a container handling vehicle 201, 301, 401 operating on the rail system 108 may move the two part storage container in its assembled configuration from a storage position within the framework structure to the base of the loading and/or unloading station. The interface 40 may be operated by the same container handling vehicle 201, 301, 401, assuming that the container handling vehicle 201, 301, 401 has the lifting device 504 with the gripper 504b shown in FIG. 12a.

When the storage container has been moved to the base 51, the two part storage container is brought to its split configuration by means of the lifting device 504, as described above. In a preferred embodiment, the base 51 comprises a holding mechanism for maintaining the base panel 11 of the lower container section 30 on the base 51 while lifting the upper container section 20.

The loading and/or unloading station 50 comprises an actuator 52 for unloading a product item or a delivery container from the storage space or for loading a product item or a delivery container into the storage space.

The same container handling vehicle may subsequently bring the two part storage container to its assembled configuration again before moving it to a storage position within the framework structure again.

In a second embodiment of the loading and/or unloading station 50 it is assumed that the second embodiment of the two part storage container 10 is used.

There are two main differences with this loading and/or unloading station 50. First, the loading and/or unloading station 50 comprises a second actuator 53 for operating the locking device 45 integrated in the base panel 11 between its locked state and its unlocked state. The second actuator 53 will typically be integrated in the base 51. Second, the special lifting device 504 with gripper 504b is not essential, as a prior art lifting device 404 with gripper 404b shown in FIGS. 11a and 11b may be used to operate the opening 41.

The operation of the second embodiment of the loading and/or unloading station 50 is similar to the first embodiment. When the storage container is located on the base, the second actuator 53 unlocks the locking device 45 of the interface 40 while the container handling vehicle operates the opening 41 of the interface 40 to bring the storage container to its split configuration before the first actuator 52 is used for loading/unloading. After the loading/unloading, the upper container section 20 is lowered by means of the lifting device of the container handling vehicle and the second actuator 53 locks the locking device 45 of the interface 40 to bring the storage container to its assembled configuration before moving it to a storage position within the framework structure again.

In the preceding description, various aspects of the storage container and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 retrieval system
10 two part storage container
11 base panel
12 side panels
12a side panels
12b side panels
13 top opening
15 cross member
16 recesses
17 apertures
18 lugs
20 upper container section
25 locking device
27 pins
30 lower container section
40 interface
41 first opening
42 second openings
45 locking device
47 pins
48 strut structure
50 loading and/or unloading station
51 base
52 first actuator
53 second actuator
70 delivery container
70to delivery container
80 product item
1 prior art automated storage and retrieval system
100 framework structure
102 upright members of framework structure
104 storage grid
105 storage column
106 storage container
106′ particular position of storage container
107 stack
108 rail system
110 parallel rails in first direction (x)
112 access opening
119 first port column
120 second port column
201 prior art container handling vehicle
201a vehicle body of the container handling vehicle 201
201b drive means/wheel arrangement/first set of wheels in first direction (x)
201c drive means/wheel arrangement/second set of wheels in second direction (y)
301 prior art cantilever container handling vehicle
301a vehicle body of the container handling vehicle 301
301b drive means/first set of wheels in first direction (x)
301c drive means/second set of wheels in second direction (y)
304 gripping device
401 prior art container handling vehicle
401a vehicle body of the container handling vehicle 401
401b drive means/first set of wheels in first direction (x)
401c drive means/second set of wheels in second direction (y)
404 gripping device
404a lifting band
404b gripper
404c guide pin
404d lifting frame
504 lifting device special lifting device
504b gripper
500 control system
X First direction
Y Second direction
Z Third direction

1.-23. (canceled)

24. A two part storage container for storing a product item in an automated storage and retrieval system, wherein the storage container, in an assembled configuration, comprises:
a base panel; and
four side panels extending from the base panel;
wherein the base panel and the four side panels define a storage space, the storage container having a top opening to provide access to the storage space;
wherein the two parts of the storage container comprise:
an upper container section comprising at least two of the side panels; and
a lower container section comprising at least the base panel;
wherein the upper container section and the lower container section are configured to allow vertical movement of the upper container section relative to the lower container section;
wherein the storage container is in a split configuration when the upper container section is at least partially separated from the lower container section.

25. The two part storage container of claim 24, wherein the storage container in the assembled configuration prevents the product item from exiting the storage space;
wherein the storage container in the split configuration allows the product item to be moved out sideways from the storage space.

26. The two part storage container of claim 25, wherein the two part storage container comprises an interface configured to bring the two part storage container between its assembled configuration and its split configuration.

27. The two part storage container of claim 24, wherein the product item is stored in a delivery container within the storage container and wherein the storage container in the assembled configuration prevents the delivery container from exiting the storage space;
wherein the storage container in the split configuration allows the delivery container to be moved out sideways from the storage space.

28. The two part storage container of claim 24, wherein the upper container section is at least partially separated from the lower container section in the split configuration.

29. The two part storage container of claim 24, wherein the upper container section comprises all four side panels.

30. The two part storage container of claim 29, wherein the lower container section comprises only the base panel.

31. The two part storage container of claim 24, wherein the upper container section comprises two side panels.

32. The two part storage container of claim 31, wherein the lower container section comprises two side panels.

33. The two part storage container of claim 30, wherein the upper container section comprises cross members that connect the two side panels of the upper container section to each other.

34. The two part storage container of claim 31, wherein the two side panels of the upper container section slidingly engage with the two side panels of the lower container section in at least the assembled configuration.

35. The two part storage container of claim 34, wherein the two side panels of the upper container section slidingly engage in recesses in the two side panels of the lower container section.

36. The two part storage container of claim 26, wherein the interface comprises:
a first opening provided in the upper container section;
a second opening provided in the lower container section;
wherein the first opening is provided above the second opening.

37. The two part storage container of claim 36, wherein the second opening is vertically aligned below the first opening in at least the assembled configuration.

38. The two part storage container of claim 24, wherein the interface comprises:
a first opening provided in the upper container section;
a locking device integrated in the base panel, wherein the locking device releasably locks the base panel to at least two of the side walls in the assembled configuration.

39. The two part storage container of claim 35, wherein the base panel comprises an aperture, wherein the side wall comprises a lug insertable into the aperture, wherein the locking device comprises a pin for releasable locking of the lug in the aperture.

40. The two part storage container of claim 24, wherein the storage container is in a split configuration when the upper container section is moved vertically relative to the lower container section.

41. An automated storage and retrieval system comprising a framework structure and a storage volume comprising storage columns, wherein a product item is stored within the two part storage container of claim 1, wherein the storage container is stackable in stacks within the storage columns; wherein the automated storage and retrieval system comprises:
a loading and/or unloading station comprising an actuator;
a lifting device comprising a gripper for lifting the upper container section relative to the lower container section;
wherein the system is configured to:
bring the two part storage container from an assembled configuration to a split configuration at the loading and/or unloading station by means of the lifting device;
load the product item into the lower container section by means of the first actuator or unload the product item from the lower container section by means of the first actuator.

42. The automated storage and retrieval system of claim 41, wherein the lifting device is arranged on a container handling vehicle.

43. The automated storage and retrieval system of claim 41, wherein the gripper is arranged to engage the first opening provided in the upper container section.

44. The automated storage and retrieval system of claim 41, wherein the gripper is arranged to selectively engage the first opening in the upper container section and/or the second opening provided in the lower container section.

45. The automated storage and retrieval system of claim 44, wherein the second opening is vertically aligned below the first opening in at least the assembled configuration and wherein the gripper has a height sufficiently large to be inserted into the first opening and the second opening in the assembled configuration.

46. The automated storage and retrieval system of claim 41, wherein the loading and/or unloading station comprises a second actuator for operating the locking device integrated in the base panel, wherein the system is configured to:
bring the storage container from the assembled configuration to the split configuration at the loading and/or unloading station by means of the lifting device lifting the upper container section with respect to the lower container section and the second actuator operating the locking device.

47. Method for loading and unloading an item from a container space of the two part storage container of claim 24, the method comprising:
transporting the two part storage container to a loading and/or unloading station;
bringing the two part storage container from an assembled configuration to a split configuration at the loading and/or unloading station by means of a lifting device comprising a gripper;
loading the product item into the lower container section by means of a first actuator or unload the product item from the lower container section by means of the first actuator.
